(19) United States
(12) Patent Application Publication
(10) Pub. No.: US 2007/0282732 A1
(43) Pub. Date: Dec. 6, 2007

(54) Electronic trade facilitation system and method

(76) Inventors: H. Evan C. Schulman, Boston, MA (US); Mark W. Hoffman, Norwell, MA (US); Paul R. Samuelson, West Newton, MA (US); Donald McRae, Chagrin Falls, OH (US)

Correspondence Address: WOLF GREENFIELD & SACKS, P.C., 600 ATLANTIC AVENUE, BOSTON, MA, 02210-2206, US

(21) Appl. No.: 11/447,577

(22) Filed: Jun. 6, 2006

(51) Int. Cl. G06Q 40/00

(52) U.S. Cl. 705/37

(57) ABSTRACT

Systems and methods configured to alert a portfolio manager (or other asset manager, investor, or proxy) as to the presence of a trade opportunity, such as an order, acceptance of which would improve a portfolio managed by the portfolio manager. The systems and methods may facilitate trading in securities that are illiquid, and additionally may increase anonymity in placing orders.

### FIELD OF THE INVENTION

The present invention relates generally to systems and methods for facilitating the trading of securities, and more specifically to systems and methods which selectively notify portfolio managers of trade opportunities based on evaluations of available trade opportunities relative to investment criteria for managed portfolios.

### DISCUSSION OF THE RELATED ART

Successfully executing trades in (usually publicly traded) securities that are somewhat or significantly illiquid can entail high transaction costs resulting in market impact that a trader may wish to avoid. A security can be illiquid by virtue of its asset type, the average daily trade volume, and/or the size of the trade. Block trades, generally considered to be a single trade of 10,000 or more shares, or $5 million or more in face value of securities, are often used by brokers or portfolio managers to buy and sell securities. Various factors, including the significant growth in assets managed by financial institutions, decimalization, and other changes in the market, have made it increasingly difficult to execute block trades. The transaction costs resulting from the inability to efficiently locate and trade with other brokers or portfolio managers when attempting block trades or trades in securities with limited liquidity is a significant challenge facing the securities industry today.

Brokers or portfolio managers desiring to buy and/or sell securities that have limited liquidity or are in block size often use one or both of two methods. In a first method, the services of an electronic matching system are used to locate and match contra orders. For example, Liquidnet™, Pipeline™ and Posit™ electronic matching systems are used for block trading of equities. TradeWeb™ and eSpeed˜ electronic matching systems are examples of systems used for block trading of fixed income securities. To use electronic matching systems, the broker or portfolio manager enters an order in the system and the system uses proprietary algorithms in an effort to match the order with a contra order.

A second method is the use of traditional agency brokers who search among their clients for an entity willing to take the contra side of a proposed trade. To find and match contra orders at a price favorable to their clients, traditional agency brokers use their knowledge and market expertise. In some cases, the brokers facilitate trades with their own capital. When dealing with equities, the brokers may operate on various exchanges and/or electronic communication networks (ECNs). Brokers typically operate on agency commissions.

While these traditional methods have certain advantages, the display of block size orders on exchanges or electronic matching systems may lead to front-running of the order, which can impact the prices ultimately obtained for the block size trade. To reduce the visibility of a block size order or an order of a security with limited liquidity, brokers or portfolio managers often place limit orders on ECNs or exchanges, without displaying the actual order. Another method of reducing the visibility of a block size order is dividing the order into several smaller orders. Unfortunately, for the brokers or portfolio managers using the tactics of placing non-displayed limit orders or posting numerous smaller orders, traders who are active in that security are typically able to infer the existence of a block size order and thus able to front-run the order. To the extent that agency brokers use these tactics, they generate the same information to other traders. To the extent that agency brokers search among their clients, the possibility exists that the broker will leak information about the order, which can lead to similar front-running problems.

### SUMMARY

Aspects of the present invention are directed to systems and methods configured to alert a portfolio manager (or other asset manager, investor, or proxy) as to the presence of a trade opportunity, such as an order, acceptance of which would improve a portfolio managed by the portfolio manager. The systems and methods disclosed herein may facilitate trading in securities that are illiquid, and additionally may increase anonymity in placing orders or posting indications of interest (IOIs). All aspects of the invention need not be present in various embodiments of the invention, although one embodiment may instantiate multiple aspects.

According to one aspect of the invention, a computer-implemented method includes an act of receiving information regarding a first entity's securities holdings in a securities portfolio, an act of receiving an indication of a benchmark (e.g., a model or a lead account) for the first entity's securities portfolio, and an act of receiving a second entity's order or indication of interest with respect to a specified security. The method also includes an act that, in response to the receipt of the order or indication of interest, determines the effect, on the first entity's securities portfolio, of executing a trade in which the second entity's order or indication of interest is accepted, by at least comparing the first entity's securities portfolio, as the securities portfolio would exist after execution of the trade, to the benchmark for the first entity's securities portfolio. A further act of the method includes notifying the first entity of an opportunity to improve its portfolio.

According to another aspect of the invention, a computer system for facilitating securities trading includes a coverage trader module which receives investment information regarding a first entity's securities portfolio, the investment information including a data record of current securities holdings or tax lots in the portfolio and a benchmark for the portfolio. The computer system also includes an order manager module which receives a second entity's order. The coverage trader module is configured to compare the portfolio with the current securities holdings to the benchmark to produce a first result. The coverage trader module is further configured to compare the portfolio, as the portfolio would exist after execution of a trade in which the second entity's order is at least partially accepted, to the benchmark to produce a second result. The coverage trader module is additionally configured to compare the first result to the second result to determine whether the second entity's order represents an opportunity for improving the first entity's portfolio relative to the benchmark, and the coverage trader module is also configured to notify the first entity of an opportunity for improving the first entity's portfolio relative to the benchmark.

According to another aspect of the invention, a computer system includes means for receiving information regarding a first entity's securities holdings in a securities portfolio, means for receiving an indication of a benchmark for the first entity's securities portfolio, means for receiving a second entity's order with respect to a specified security, and means for comparing the portfolio with the current securities holdings to the benchmark to produce a first result. The system further includes means for comparing the portfolio, as the portfolio would exist after execution of the trade, to the benchmark to produce a second result, means for comparing the first result to the second result to determine whether the first entity's order represents an opportunity for improving the second entity's portfolio relative to the benchmark, and means for notifying the first entity of an opportunity to improve the portfolio relative to the benchmark.

According to another aspect of the invention, a computer-readable medium has computer-readable signals stored thereon that define instructions that, as a result of being executed by a computer, instruct the computer to perform a method including acts of: receiving information regarding a first entity's securities holdings in a securities portfolio; receiving an indication of a benchmark for the first entity's securities portfolio; receiving a second entity's order or indication of interest with respect to a specified security; in response to the receipt of the order or indication of interest, determining the effect, on the first entity's securities portfolio, of executing a trade in which the second entity's order or indication of interest is accepted, by at least comparing the first entity's securities portfolio, as the securities portfolio would exist before and after execution of the trade, to the benchmark for the first entity's securities portfolio; and notifying the first entity of an opportunity to improve its portfolio.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For the purposes of clarity, not every component is labeled in every figure, nor is every component of each embodiment of the invention shown where illustration is not necessary to allow those of ordinary skill in the art to understand the invention.

In the figures:

FIG. 1 shows a schematic view of one embodiment of an electronic trade facilitation system;

FIG. 2 is a flow chart illustrating a method of facilitating trading according to one aspect of the invention;

FIG. 3 is a schematic diagram illustrating the generation of a benchmark for a portfolio;

FIGS. 4a and 4b show a method of executing a trade according to another aspect of the invention;

FIG. 5 is a diagram of an electronic trade facilitation system architecture according to one aspect of the present invention;

FIG. 6 shows a schematic view of one embodiment of an electronic coverage trader module;

FIG. 7 is a block diagram illustrating an example of a computer system on which some embodiments of the invention may be implemented; and

FIG. 8 is a block diagram illustrating an example of a storage system that may be used as part of the computer system to implement some embodiments of the invention.

### DETAILED DESCRIPTION

In one aspect, a system, referred to herein as an electronic coverage trader (ECT) system, maintains a record of the holdings or tax lots, benchmarks (i.e., goals or reference indices) and constraints for each of a number of portfolios. When an order (or an IOI) is entered into the system (by a broker for example), the system evaluates the trade opportunity relative to each portfolio to determine whether accepting the trade opportunity would improve the portfolio in relation to the benchmark(s) provided for the portfolio. For portfolios that would benefit from executing a trade, the system also checks the trade opportunity against constraints set by the portfolio manager and/or checks for regulatory compliance. When a trade opportunity both improves a portfolio and passes the constraint and compliance tests, the system notifies the portfolio manager of the trade opportunity.

The notification provides the portfolio manager with the ability to accept or reject the trade opportunity. If the portfolio manager accepts the trade opportunity, the order is locked and the broker is notified. In some cases, the portfolio manager may grant acceptance authority to the system (acting as the manager's proxy or agent) such that a response by the portfolio manager is not needed to accept certain or all trade opportunities identified by the system as beneficial to the portfolio.

Instead of broadcasting an order (or an IOI) on an ECN or an exchange, or electronic matching systems, the ECT targets the communication of the order to one or more entities (e.g., portfolio managers) who have been pre-screened based on the value of the trade opportunity relative to their portfolio(s). Limiting the visibility of an order (or an IOI) by alerting only certain prospective trading entities reduces the possibility of front-running or other information leakage problems.

Additionally, from the portfolio manager's perspective, in some embodiments, the only trade opportunity notifications received by the portfolio manager are for opportunities that have been evaluated by the system to provide a portfolio improvement. Because the evaluation is based on investment criteria selected by the portfolio manager, the portfolio manager is able to reduce the time spent sifting through opportunities which, according to his or her own criteria, do not provide portfolio improvements.

Some embodiments of the present invention provide a computerized system that allows a portfolio manager to define investment criteria for a portfolio and then receive notifications of trade opportunities entered into the system by others, if those trade opportunities will improve his or her portfolio in relation to the investment criteria. When the trade opportunity represents an order that has been placed in the system, the portfolio manager may accept, resulting in a trade that improves the portfolio. In this manner, the process of reviewing orders, or in some cases IOIs, can be automated such that the portfolio manager is presented only with opportunities that have been determined to be advantageous. In some embodiments, the investment criteria include a benchmark which provides a risk/return target for the portfolio. In some embodiments, the investment criteria include constraints so that unacceptable opportunities are also screened out before a portfolio manager is notified. Additional possible investment criteria include tax-related information, lists of security rankings, regulatory compliance restrictions, and methods of assessing transaction costs.

From the perspective of entities entering orders into the system, the reduced visibility of the orders can help to limit opportunistic trading such as front-running when trading of illiquid securities is involved. A broker (or other entity) may feel more comfortable placing a block-size order when he or she knows that the only portfolio managers who see the order are ones who would benefit from the opportunity, and these portfolio managers are alerted quickly both as to the presence and desirability of the opportunity. Additionally, because in some embodiments multiple portfolio managers are notified simultaneously of opportunities, acceptance of an opportunity may be quick because each portfolio manager may be concerned about another portfolio manager accepting first and usurping the opportunity. The system also may be configured to track the responses of portfolio managers such that disciplinary action may be taken against those who seem to be using the system to gain information about the activity of others rather than to trade.

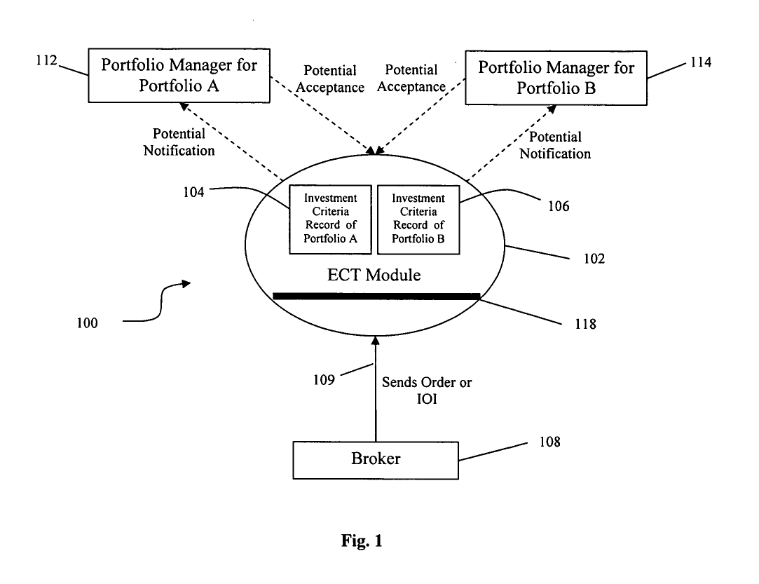

A diagrammatic illustration of the relationships between users of one embodiment of a trade facilitation system 100 is shown in FIG. 1. An electronic coverage trader (ECT) module 102 maintains investment criteria records 104, 106 for a number of portfolios (e.g., A, B) for subscribing investors or managers. Investment criteria records 104, 106 for each portfolio may include a catalog of the securities holdings, performance or asset allocation benchmarks, constraints, regulatory compliance information, tax information, securities rankings, expected transaction costs, and other information relevant to the portfolio.

A broker 108 or other entity, sends an order to ECT module 102 indicated by an arc (i.e., directional line) 109. It should be noted that while brokers, portfolio managers, investors, and institutions are terms used throughout this application to refer to various parties, in most cases any suitable party may be on either side of a trade or proposed transaction. Additionally, for purposes herein, an entity such as a broker or a portfolio manager is intended to include other proxies and delegates for the entity. ECT module 102 evaluates what the effect would be on each portfolio if a portfolio manager such as 112, 114 were to take advantage of the opportunity presented by the order. If the effect is determined to improve a portfolio, or to meet a predetermined threshold such as an improvement threshold, the appropriate portfolio manager is notified of the opportunity to execute that trade. In some embodiments, if notified, the portfolio manager is provided with all of the relevant order information (security, size of order, price per unit, etc.) except the identity of broker 108. In other embodiments, less or more information is provided to the portfolio manager.

If ECT module 102 determines that the effect of accepting an order would be to harm the portfolio, or lead to a small improvement that does not meet an improvement threshold, the portfolio manager is not notified of the opportunity, and in this manner, broker 108 is shielded from unnecessary exposure of the order.

In addition to evaluating the effect on a portfolio of accepting an opportunity, ECT system 102 also may check the opportunity against constraints defined by the portfolio manager and/or check for regulatory compliance.

When portfolio managers 112, 114 receive notification of an order (i.e., an offer), they are provided with an opportunity to accept the order (offer). This acceptance may occur by responding via a web browser interface or by sending an electronic message, as examples, or by any other suitable method. Upon receipt of acceptance, ECT module 102 notifies broker 108 of the acceptance and broker 108 “prints” the order. In some embodiments, the trade data is passed to a separate transaction system to complete the trade. While the actual execution of the trade may occur outside of system 100, in some embodiments, the execution may occur partially or wholly within system 100. Once an order is accepted, the order is removed from the system and, in some embodiments, portfolio managers who had not yet accepted the trade opportunity are notified that it is no longer available. It should be noted that “accepting an order” or “accepting a trade opportunity”, may comprise placing a contra order with the intention that the original order and the contra order be matched and a trade executed. “Accepting an order” also may comprise accepting a portion of the order, for example, placing a contra order for half of the shares offered for sale or purchase in the initial order.

According to one aspect of the invention, the system may provide a “wall of anonymity” 118 that prevents unnecessary and/or illegal information from passing between entities. For example, the investment criteria for the various portfolios, while known to the ECT module, are not communicated to anyone other than back to the manager of that portfolio. In embodiments where the system is configured to act for the portfolio managers during the actual execution of trades, broker 108 and the institution holding the relevant portfolio may never be made known to one another, even after the trade. And, as discussed above, the orders submitted by broker 108 are only communicated to portfolio managers when the orders pass a series of evaluations and/or tests.

While several embodiments of the present invention have been described and illustrated herein, those of ordinary skill in the art will readily envision a variety of other systems, methods, means and/or structures for performing the functions and/or obtaining the results and/or one or more of the advantages described herein, and each of such variations and/or modifications is deemed to be within the scope of the present invention. For example, instead of entering an order into ECT module 102, broker 108 may enter an IOI. Upon being notified of the IOI, a portfolio manager may place a counter offer or anonymously start electronic negotiations with broker 108 which may ultimately lead to an executed trade.

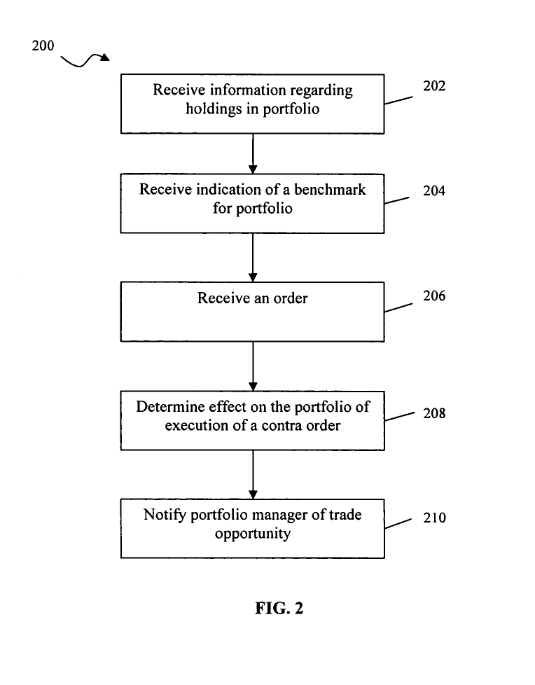

A method 200 of facilitating a trade according to one embodiment of the invention is illustrated in FIG. 2. In method 200, an application, computer, server or other system receives various inputs via user interfaces or other electronic communication. For example, in an act 202, information regarding the securities tax lots or holdings of a portfolio is received. The holdings/tax lots of a large number of portfolios may be received from a large number of subscribing institutions. The information regarding the holdings/tax lots may be received in any suitable format. In some embodiments, an automated interface from a portfolio manager allows regular, e.g., nightly, downloads that provide the system with holdings/tax lots information regarding investors/portfolios. In some embodiments, the system is “hot-linked” to a subscribing institution's or portfolio manager's server for continuous or nearly continuous updating. Holdings/tax lots information resulting from trades facilitated by the system may be used to automatically update the holdings/tax lots records within the system in some embodiments. In some embodiments, the system may receive new data via a manual interface, e.g., allowing a user to type in holdings. The system may be configured to receive data feeds that provide information on stock splits and dividends, also, to maintain accurate information regarding the holdings/tax lots associated with portfolios.

To capture information regarding the risk/return objectives for each portfolio, a benchmark for a portfolio may be provided by the portfolio manager. In an act 204, an indication of the benchmark, model portfolio or lead account is received. Portfolio managers can choose to use benchmarks such as the S&P 500 or the Wilshire 5000 indices. In some embodiments, a portfolio manager may establish a customized benchmark that meets his or her risk/return objectives. For purposes herein, the term “indication of a benchmark” is intended to encompass any communication or transmission of data that signifies, selects or defines a benchmark, whether it be the provision, maintenance or receipt of the indication. For example, indicating that the S&P 500 index is to be used as a benchmark is considered to be providing an indication of a benchmark. Likewise, receiving a file that lists a set of securities or defines risk/return parameters or an asset/allocation target profile is considered to be receiving an indication of a benchmark.

Benchmarks are used to define a standard against which to measure a portfolio. For example, portfolio holdings may be compared against the selected benchmark in terms of diversification, sector exposure, factor exposure, the value-weighted average ranking of the securities therein, performance, and/or other attributes. The benchmark may include target allotments for each “sector”, a reference to a sector categorization scheme (to determine which securities comprise a particular “sector”), and a target for each of various factors (e.g., price/earnings ratio, market cap, price/book ratio, beta, yield, etc.). Information used to calculate the various factors and data points may be downloaded on a periodic basis and stored locally, or, in some embodiments, retrieved in real-time from outside systems or services.

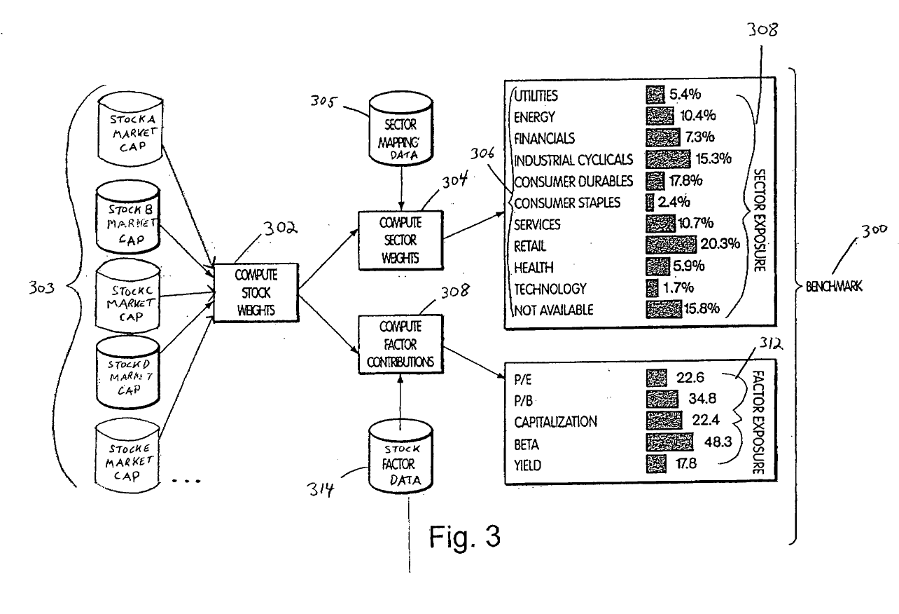

FIG. 3 is a dataflow diagram illustrating the generation of one example of a benchmark from a set of securities such as stock A, stock B, stock C, stock D, stock E, etc. In the embodiment illustrated in FIG. 3, a benchmark 300 includes an industry sector exposure 308 and a factor exposure 312. In some embodiments, other exposures or standards may be included as part of benchmark 300.

As part of determining these exposures, each stock's market capitalization weight is calculated in a module 302 as a percentage of the total market capitalization of all of the stocks used to establish a benchmark 300. To generate the benchmark's sector exposure, sector mapping data 305 is used to categorize stocks 303 into selected sectors 306. The market capitalization weight of each stock is then added to one or more sectors in a sector weighting module 304 to arrive at sector exposures 308.

Factor exposures 312 for the benchmark may be calculated using stock factor data 314 for each of stocks 303. To calculate the benchmark's facture exposure for one factor, for example the price/earnings ratio, each stock's market capitalization weight is multiplied by that stock's price/earnings ratio. The results of the calculation for each of the stocks are summed to arrive at a weighted price/earnings ratio factor exposure. This calculation is repeated for each factor, for example, the price/book value ratio, capitalization, beta, yield, etc.

A customized benchmark can be created by selecting individual stocks to include in the benchmark, or a standard benchmark such as the S&P 500 index may be used.

Referring again to FIG. 2, in an act 206, an order is received. The order may be received from any entity, including a broker or an institutional or other investor. The entity may be a portfolio manager who subscribes (or whose institution subscribes) to the system on the portfolio management side. The order is a firm order that becomes binding if and when a portfolio manager accepts the trade opportunity, or until cancelled. By requiring an actual order to be entered into the system, brokers are dissuaded from probing for information about the participants in the system without committing to a position. In some embodiments, however, the system may accept IOIs or other non-binding offers in a limited capacity in an effort to generate liquidity.

The order may be received in any suitable manner, such as via a web browser or another electronic communication method. In some embodiments, the system is configured to handle large numbers of orders from large numbers of entities. In this manner, the system can potentially provide numerous trade opportunities to entities such as subscribing investors. As used herein, “receiving from an entity” does not require receiving directly from the entity. For example, a computer-implemented system configured to receive an order from a broker may receive or be configured to receive the order from an intermediate party or electronic system, ECN or exchange. Such a system would still be considered to be configured to receive an order from the broker.

An evaluation of the received order is performed in an act 208. The system performs a “what-if” analysis to determine the effect of accepting the trade opportunity.

If the system determines that accepting the trade opportunity meets certain criteria, the system notifies the portfolio manager for the portfolio of the trade opportunity in an act 210. For example, the evaluation could reveal that accepting the trade opportunity would improve the portfolio relative to the benchmark by at least a certain threshold, and the portfolio manager is notified of the opportunity. In some embodiments, values or other descriptors of the amount and kind of improvement, or a standardized improvement score, are communicated with the trade opportunity notification.

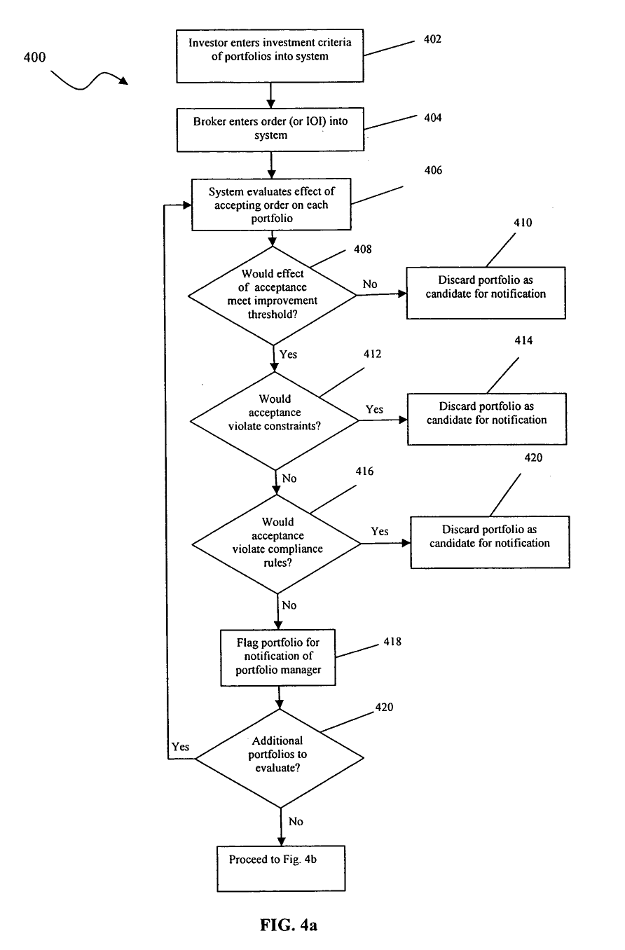

As described further below with regard to FIGS. 4a and 4b, further evaluations and checking against constraints may be performed before notifying a portfolio manager of a trade opportunity. Additionally, the system may evaluate most or all of the portfolios that are in the system before notifying any portfolio managers. In this manner, notifications may be sent to portfolio managers simultaneously or nearly simultaneously.

A method 400 of executing a trade, including acts of checking a trade opportunity for violation of regulations or other policies and checking for violations of constraints defined by a portfolio manager, is illustrated in FIGS. 4a and 4b. According to this method, portfolio managers are aided by the system in evaluating trade opportunities and executing trades.

In an act 402, a subscribing entity enters investment criteria for portfolios into the system. In an act 404, a broker or other entity enters an order or an IOI into the system. In the embodiment illustrated in FIGS. 4a and 4b, acts 406 through 422, 426, 428 and 432 are performed by the system, while acts 402, 404, 424, 430 are performed by an entity or entities other than the system. An act 434 of executing a trade can occur within the system or outside of the system.

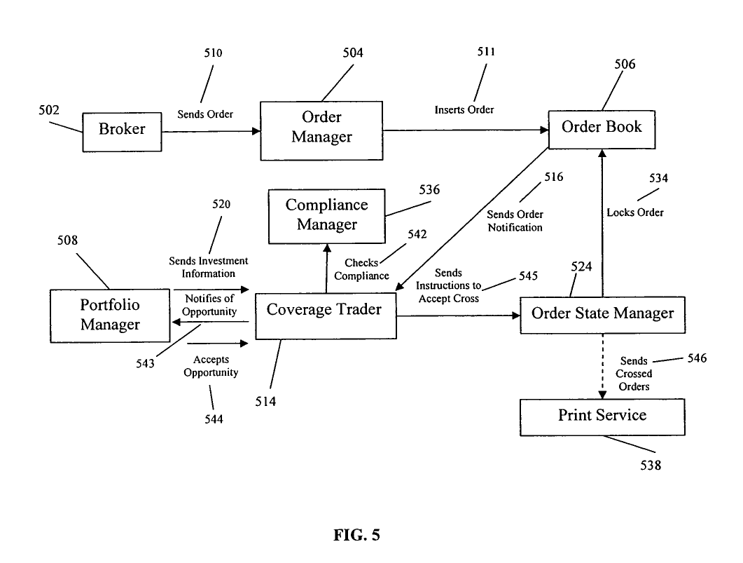

In act 406, the system evaluates the effect accepting the order would have on each portfolio. As described further below with reference to FIG. 6, this evaluation may include analyses of various factors including: the tracking error of the portfolio relative to its benchmark(s); tax consequences; security rankings; and transactions costs. In some embodiments, an assessment is performed using the current holdings found in the portfolio, and the result is compared to an assessment performed using the holdings as they would be if a certain trade opportunity were to be accepted. The two assessments are compared, and if the difference meets or exceeds an improvement threshold in act 408, the trade opportunity is passed along to a next test. If the improvement threshold is not met, the portfolio is discarded as a candidate for notification of the pending trade opportunity in act 410.

In some embodiments, evaluations that show a slight reduction in the assessment results of a portfolio may nonetheless be maintained as a candidate for notification. For example, if no portfolios would experience an improvement based on a trade opportunity, those portfolio managers for portfolios found to experience only a slight reduction may be notified in case the portfolio manager is interested in the opportunity. Such a notification may include a warning that the evaluation indicated only a slight reduction in assessment results. Similarly, portfolio managers may be given the option to refuse notifications of trade opportunities that do not represent improvements (or greater-than-a-threshold improvement) to the portfolio.

In some embodiments, in addition to evaluating the effect on the portfolio of accepting a trade opportunity by using cash reserves, the system evaluates the effect of selling securities that are currently contained in the portfolio to free up capital to buy securities that have been offered in an order. For example, assume a broker places an order to sell 20,000 shares of XYZ. For a given portfolio, the system evaluates the effect of selling an adequate amount of one of the securities currently held in the portfolio to generate the required cash. A similar evaluation is performed for each potential sell candidate in the portfolio. Once the evaluations are complete, the system selects the security sale that provided the largest portfolio improvement and provides its sale as a recommendation to the portfolio manager. For example, after evaluating the (e.g., eighteen) securities held in a portfolio, the system may recommend that it would be best to sell shares of ABC in order to purchase XYZ. This recommendation can be presented to the portfolio manager along with the notification of the trade opportunity. The notification may be configured such that acceptance of the trade opportunity (i.e., buy XYZ) automatically instructs the system to enter into the system an order for selling ABC, or make that acceptance conditional on selling ABC. In other cases, the notification is configured to allow for acceptance of the trade opportunity, but the portfolio manager is tasked with acting on the recommendation of selling security ABC.

In some embodiments, the system includes an optimization module to analyze the multiplicity of possibilities for selling a mixture of securities from the portfolio when accepting an opportunity to buy a security (see FIG. 6 and associated description). The optimization module may use linear programming or quadratic programming, or any other suitable optimization method. As with many optimization methods, when analyzing computationally-intensive numbers of possibilities, an absolutely optimal result is not necessarily located.

In some embodiments, the system analyzes securities available for purchase when evaluating a portfolio manager's opportunity to sell securities from a portfolio. For example, a broker may enter into the system an order buy 30,000 shares of QQQ. For a portfolio holding shares of QQQ, the system evaluates buying various securities with the proceeds that would be realized by selling QQQ. The system may be configured to evaluate purchases only of securities which are already contained in the portfolio, or only securities contained on a preferred list of securities. In some embodiments, the system is configured to evaluate large numbers of securities available on various exchanges. The system may automatically enter the purchase order(s) or make the sale conditional on the purchase(s) so suggested. As before, an optimization module may be included in the system.

In act 412, the trade opportunity is tested against constraints provided for the portfolio. For example, the portfolio manager may restrict the purchase of certain securities, e.g., so-called “sin stocks”. In some cases, the portfolio manager may provide limits on: investments in a certain industry; certain sector or factor risks; or the ratio of certain securities to one another. In still other cases, the portfolio manager may require a minimum amount of certain securities be maintained within the portfolio, or may prohibit trading with a certain entity. Another possible constraint is the recognition and/or prevention of the potential purchase of a stock that was sold within a 30-day wash period. Any suitable constraint could be defined by the portfolio manager as the particular type of constraint is not intended to be limiting.

As with act 406, if the combination of the trade opportunity with the portfolio passes the constraint test, i.e., the system determines that the trade would not violate any constraint, the portfolio is passed along to a next test. If any constraint would be violated by acceptance of the trade opportunity, the portfolio is discarded as a candidate for notification in act 414. In some embodiments, a portfolio manager may define constraints that allow a portfolio, even if it does not pass the constraint test, to move forward through method 400, but with an attached identification of a constraint or guideline that would be violated by the trade opportunity.

Compliance rules, such as regulatory compliance rules, are examined in act 416. For example, compliance with the Investment Company Act of 1940 may be checked in act 416. If it is determined that executing the potential trade would not violate compliance rules for the particular portfolio being examined, the portfolio is flagged in act 418 for notification of the portfolio manager. If it is determined that the potential trade would violate compliance rules, then the portfolio is discarded as a candidate for notification in act 420.

The above-described group of acts in which the effects of accepting a trade opportunity are tested for a portfolio do not need to be performed in the order presented. Compliance and/or constraint check acts may be performed before the evaluation act. The acts may be performed serially or in parallel. The acts may be performed on each portfolio in turn, or, in some embodiments, one of the above acts 408, 412, 416 may be performed for each (or a group) of the portfolios before the next act is performed on each of the portfolios. In some embodiments, additional tests and/or analysis may be performed, and one or more of the above-described tests may be omitted.

In act 420 the system checks whether additional portfolios remain for evaluation, and once no more portfolios remain, the system notifies the portfolio managers for the candidate portfolios in act 432. The notification may be sent simultaneously to each of the portfolio managers. In some embodiments, the system does not check that no more portfolios remain for evaluation before the managers of candidate portfolios are notified.

In some cases the precise time of sending an electronic communication to each portfolio manager may differ slightly. In such cases, the system may be configured to prioritize the order in which the notifications are sent. The prioritization may incorporate response results from previous trade opportunities. For example, a first portfolio manager who historically has accepted a higher percentage of trade opportunities than a second portfolio manager may be placed ahead of the second portfolio manager for notification purposes. In another example, candidate portfolios may be prioritized according to the relative improvements to be realized by the portfolios. In these embodiments, a notification would be sent slightly earlier to a portfolio manager for a portfolio that would see a large improvement from acceptance of the trade opportunity than to a portfolio manager for a portfolio that would see a marginal improvement.

In an alternative embodiment, portfolio manager notifications may be prioritized and sent sequentially, waiting for a response or time limit expiration from each portfolio manager before notifying the next portfolio manager on the priority list.

In some embodiments, the first portfolio manager to respond to a notification locks sufficient of the trade to satisfy his contra order. In an alternative embodiment, a short time period is provided and all notified portfolio managers are given the chance to accept the order at a price that is better for the broker. In such an embodiment, the portfolio manager who, during the time period, places a contra order that is most attractive to the broker locks sufficient of the trade to satisfy his contra order.

Regardless of the methods of notification and acceptance, if an acceptance is noted in act 426, the broker is notified in act 428 that a trade opportunity has been accepted and the broker prints the trade in act 430. In some embodiments, the system sends orders to a so-called print service which processes the trade. When a trade opportunity is accepted by a portfolio manager, the system notifies the remaining portfolio managers that the trade opportunity is no longer available in some embodiments.

If an order is not accepted during a specified time period, the broker is notified in an act 432. In act 434, the trade is executed.

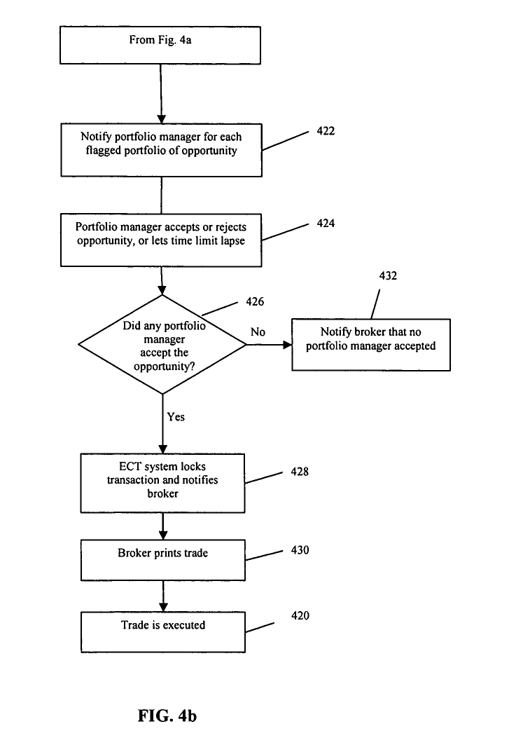

FIG. 5 illustrates the system architecture for one embodiment of an electronic trade facilitation system. Many of the modules described in FIG. 5 may be implemented in software, hardware and/or firmware. Data passed between modules may be sent over a network, within the same application, or along any other suitable communication network(s) or link(s).

On one side of a potential trade, in an act 520, a portfolio manager 508 sends investment information for one or more portfolios to a coverage trader module 514. The information for each portfolio is sent in the form of a data record that includes various fields. For example, a data record may include fields for each of: a list of currently held securities; one or more benchmarks or models for performance and/or risk/return goals; a list securities rankings; a set of constraints on trading certain securities; a set of constraints (minimum and/or maximum) on quantities of certain securities to hold; a set of constraints on ratios of certain securities; tax consequence information such as purchase date and/or cost basis for various holdings; and transaction cost information. In some embodiments, not every one of these fields is required, and in some embodiments, additional fields are included.

Coverage trader module 514 stores the data records received from the portfolio manager(s), whether it be within the coverage trader module 514 itself, or within a separate module (not shown) from which coverage trader module 514 may receive the data records when needed.

On the opposite side of a potential trade, in an act 510, a broker 502 sends an order to an order manager module 504. The order includes a data structure that includes an indication of a security, a type of order (e.g., market order or limit order), and a direction of the order (i.e., buy or sell). The data structure also may include the number of shares, a price or a limit price. Special handling instructions also may be included within the data structure. Order manager module 504 inserts this order into an order book module 506 in an act 511. Order book module 506 maintains a list of open orders.

When a new order is received from order manager module 504, order book module 506 sends an order notification to coverage trader module 514 in an act 516. The order notification includes a data structure that includes an indication of a security, the number of shares, price, and the direction of the order. Coverage trader module 514 analyzes the effect on each portfolio of accepting the offered order. For portfolios that would benefit from accepting the order (or meet a selected threshold of improvement), coverage trader module 514 calls on a compliance manager 536 in an act 542 to check if any regulatory compliance requirements are violated. If compliance manager 536 determines that no violations exist for a given portfolio, the portfolio is added to a list of candidate portfolios. When calling on compliance manager 536, coverage trader 514 sends a data structure including an indication of the security, the number of shares, and the direction of the order.

For candidate portfolios, coverage trader module 514 checks if any constraints would be violated by executing the trade. Examples of constraints are provided above in the description of act 520. In some embodiments, constraint checking within coverage trader module 514 may be performed as part of the portfolio improvement analysis that designates candidate portfolios, and not as a separate act. In some embodiments, a separate constraint manager module (not shown) may be used to check constraints.

Coverage trader module 514 notifies the portfolio manager 508 for each of the candidate portfolios that a trade opportunity exists in an act 543. The notification includes information regarding the security, the price, the size of the order, and statistics that may assist the portfolio manager in determining the quality of the opportunity as it pertains to the portfolio and the associated investment criteria. If broker 502 has agreed to reveal their identity, the notification may include this information as well. Of course, not all of this above-described information is required to be included within a notification, and in some embodiments, portfolio manager 508 may prescribe which information or statistical analyses should be included within a notification.

If portfolio manager 508 decides to accept the trade opportunity, portfolio manager 508 instructs coverage trader module 514 to accept the trade opportunity in an act 544. In some embodiments, portfolio managers are provided with the option of delegating acceptance authority to coverage trader module 514. For example, if portfolio manager 508 delegates acceptance authority to coverage trader module 514, and only a single portfolio is determined to be a candidate portfolio, coverage trader module 514 may be configured to automatically accept the trade opportunity on behalf of portfolio manager 508. In some embodiments, when multiple portfolio managers delegated acceptance authority to coverage trader module 514, coverage trader module 514 may be configured to accept a trade opportunity for the portfolio(s) that would realize the greatest improvement from the trade.

In an act 545, coverage trader module 514 sends instructions to order state manager module 524 to execute the cross, print the trade, and notify broker 502 and portfolio manager 508. The instructions include information identifying all or a portion of the broker's order, and information identifying the contra-side to the order. Order state manager module 524 locks the order by instructing, in act 534, order book module 506 to remove the order from the open order list. In doing so, order state manager sends a data structure including an indication of the security, the number of shares, and the direction of the contra order to order book module 506.

In an act 546, order state manager module 524 sends the cross to a print service module 538 to process the trade. Act 546 includes sending a data structure including an identification of the broker's original order and the contra-side to that order which was accepted by the portfolio manager. Additionally included is information regarding the trading parties which is used to clear and settle the trade. Print service module 538 also may send a notification (not shown) to order manager module 504 which sends a notification (not shown) to broker 502 and portfolio manager 508. Alternatively, the order state manager module 524 may send the order to broker 502 for printing.

With any of the above-described data structures, less or additional information may be included when information is sent between modules. In some embodiments, not all of the information is sent within a single communication, or within the same data structure.

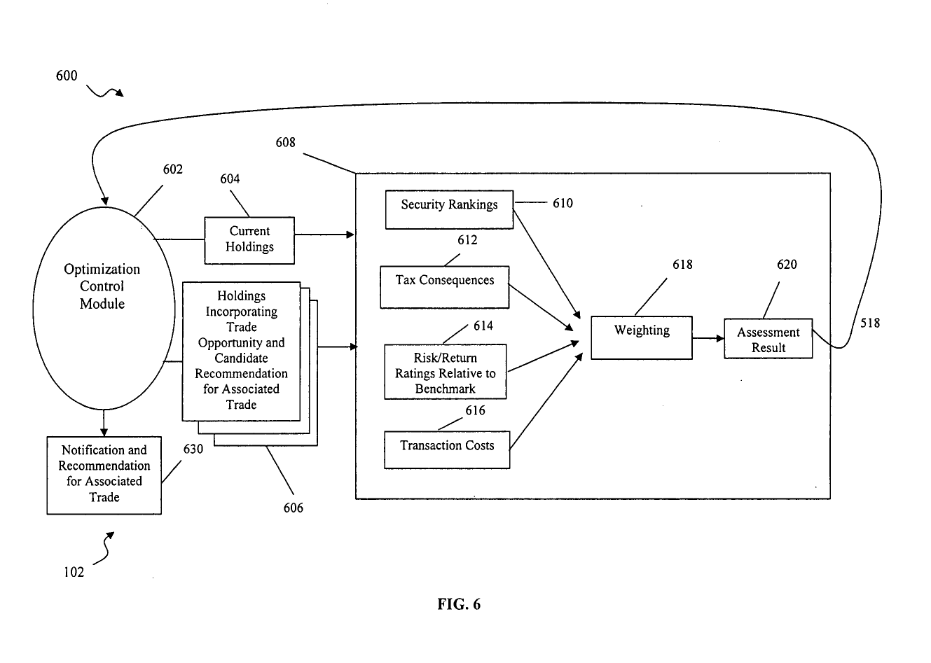

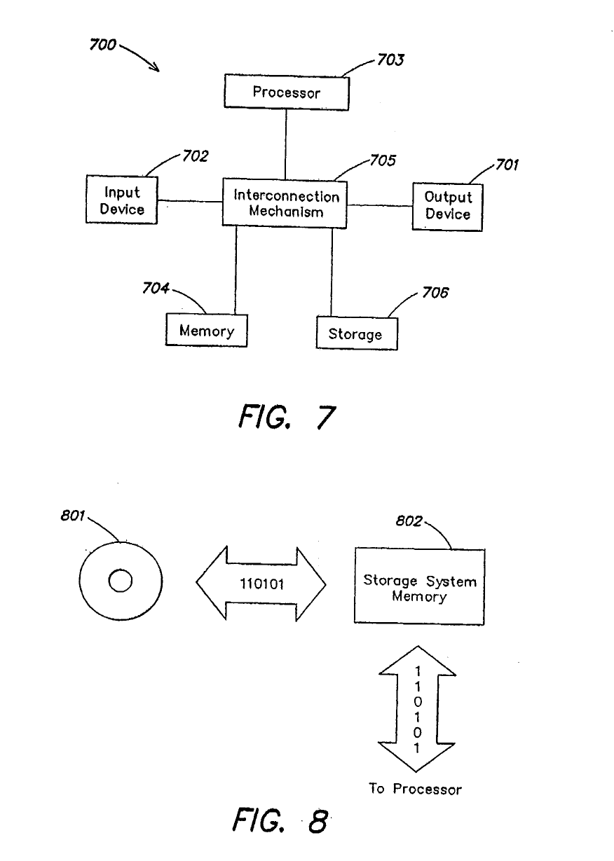

Other software, hardware, and/or firmware structures may be used to perform the various methods and functions described herein, as described in more detail below with reference to FIGS. 7 and 8, and the embodiment shown and described with reference to FIG. 5 is provided only as one embodiment.

FIG. 6 schematically illustrates one embodiment of ECT module 102. In this embodiment, an optimization module or engine 600 uses data sets 604, 606 in an assessment module 608. Data set 604 contains current holdings/tax lots, while data sets 606 contain candidate portfolio holdings, each representing a “what-if” scenario incorporating a trade opportunity and a candidate associated trade (e.g., a security sale to partially or wholly offset a buy opportunity that has been entered into the system). Optimization engine 600 may include an optimization control module 602 to direct the optimization procedures.

Assessment module 608 evaluates each data set 606 using various investment criteria modules 610, 612, 614, 616 and a weighting 618 of the investment criteria module outputs to produce an assessment result 620 for each data set. Assessment module 608 also may evaluate the current holdings data set 604 to produce a baseline assessment result 620 against which assessment results for trade opportunities and candidate associated trades may be measured. The assessment result for each data set 606 is sent back to optimization control module 602 where, based on the assessment result feedback, a new candidate portfolio may be generated and sent to the assessment module. Once optimization control module 602 has determined that accepting a trade opportunity presents an improvement to the portfolio under evaluation, and has selected a recommendation for an associated trade, optimization control module 602 sends the notification and recommendation 630 to a portfolio manager or other party.

Within assessment module 608, various sub-modules prepare an assessment of the holdings or of the proposed transaction(s) and resulting holdings. A securities ranking module 610 assembles and normalizes the rankings for the securities included in the data set used by assessment module 608. A tax consequences module 612 computes the tax consequences for the proposed buy and/or sell actions that would occur if the opportunity and the recommendation for an associated trade were to be accepted. A risk/return benchmark comparison module 614 computes the tracking difference between the benchmark and the candidate or current portfolio. Module 614 may compute the tracking difference for one aspect of the benchmark, such as an asset sleeve, or module 614 may compute the tracking difference for a number of aspects of the benchmark. A transaction costs module 616 computes the transaction costs of accepting the opportunity and the recommendation for an associated trade. A weighting module 618 is used to balance the various criteria used in assessing a given trade opportunity.

The use of the methods and systems described herein may be computer-implemented. Software can be used, for example, to obtain data, store data, organize data, analyze data, optimize decisions and to communicate with investors such as portfolio managers. When a computer-based method is used, some or all of the data and communications may be encrypted using any acceptable cryptographic system, to protect the privacy and security of the data.

Some of the methods described herein and various embodiments and variations of the methods and acts, individually or in combination, may be defined by computer-readable signals tangibly embodied on more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can be accessed by a computer, and any suitable combination of the foregoing. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Each of the systems described herein and illustrated in FIGS. 1-6, and components thereof, may be implemented using any of a variety of technologies, including software (e.g., C, C#, C++, Java, Visual Basic, Fortran, Pascal, Eiffel, Basic, COBOL or a combination thereof), hardware (e.g., one or more application-specific integrated circuits), firmware (e.g., electrically-programmed memory) or any combination thereof. One or more of the components may reside on a single device (e.g., a computer), or one or more components may reside on separate, discrete devices. Further, each component may be distributed across multiple devices, and one or more of the devices may be interconnected.

Further, on each of the one or more devices that include one or more components of the systems, each of the components may reside in one or more locations on the system. For example, different portions of the components of these systems may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. The systems, and components thereof, may be implemented using a computer system such as that described below in relation to FIGS. 7 and 8.

A general-purpose computer system according to one embodiment of the invention is configured to perform any of the functions described above. It should be appreciated that the system may perform other functions and the invention is not limited to having any particular function or set of functions.

For example, various aspects of the invention may be implemented as specialized software executing in a general-purpose computer system 700 such as that shown in FIG. 7. The computer system 700 may include a processor 703 connected to one or more memory devices 704, such as a disk drive, memory, or other device for storing data. Memory 704 is typically used for storing programs and data during operation of the computer system 700. Components of computer system 700 may be coupled by an interconnection mechanism 705, which may include one or more busses (e.g., between components that are integrated within a same machine) and/or a network (e.g., between components that reside on separate discrete machines). The interconnection mechanism 705 enables communications (e.g., data, instructions) to be exchanged between system components of system 700. Computer system 700 also includes one or more input devices 702, for example, a keyboard, mouse, trackball, microphone, touch screen, and one or more output devices 701, for example, a printing device, display screen, speaker. In addition, computer system 700 may contain one or more interfaces (not shown) that connect computer system 700 to a communication network (in addition or as an alternative to the interconnection mechanism 705.

The storage system 706, shown in greater detail in FIG. 8, typically includes a computer readable and writeable nonvolatile recording medium 801 in which signals are stored that define a program to be executed by the processor or information stored on or in the medium 801 to be processed by the program. The medium may, for example, be a disk or flash memory. Typically, in operation, the processor causes data to be read from the nonvolatile recording medium 801 into another memory 802 that allows for faster access to the information by the processor than does the medium 801. This memory 802 is typically a volatile, random access memory such as a dynamic random access memory (DRAM) or static memory (SRAM). It may be located in storage system 706, as shown, or in memory system 704. The processor 703 generally manipulates the data within the integrated circuit memory 802 and then copies the data to the medium 801 after processing is completed. A variety of mechanisms are known for managing data movement between the medium 801 and the integrated circuit memory element 802, and the invention is not limited thereto. The invention is not limited to a particular memory system 704 or storage system 706.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 700 is shown by way of example as one type of computer system upon which various aspects of the invention may be practiced, it should be appreciated that aspects of the invention are not limited to being implemented on the computer system as shown in FIGS. 7 and 8. Various aspects of the invention may be practiced on one or more computers having a different architecture or components than that shown in FIGS. 7 and 8.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on an n-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol. The use of “including,” “comprising,” or “having,” “containing”, “involving”, and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method comprising:
(a) receiving information regarding a first entity's securities holdings in a securities portfolio;
(b) receiving information on or an indication of a benchmark for the first entity's securities portfolio;
(c) receiving a second entity's order or indication of interest with respect to a specified security;
(d) in response to the receipt of the order or indication of interest, determining the effect, on the first entity's securities portfolio, of executing a trade in which the second entity's order or indication of interest is accepted, by at least comparing the first entity's securities portfolio, as the securities portfolio would exist before and after execution of the trade, to the benchmark for the first entity's securities portfolio; and
(e) notifying the first entity of an opportunity to improve its portfolio.

2. A computer-implemented method as in claim 1, wherein (c) comprises receiving an order of the second entity.

3. A computer-implemented method as in claim 2, wherein (c) comprises receiving only an order of the second entity.

4. A computer-implemented method as in claim 1, wherein (d) comprises, in response to the receipt of the order or indication of interest, determining the effect, on the first entity's securities portfolio, of executing a trade in which the second entity's order or indication of interest is partially accepted.

5. A computer-implemented method as in claim 3, wherein (a) further comprises receiving information regarding securities holdings in a multiplicity of securities portfolios of a multiplicity of entities;
(b) further comprises receiving information on or indications of benchmarks for the multiplicity of securities portfolios; and
(c) further comprises receiving a multiplicity of orders from a multiplicity of entities with respect to specified securities.

6. A computer-implemented method as in claim 5, wherein (d) further comprises, in response to receipt of the second entity's order, determining the effect, on each of the multiplicity of securities portfolios, of executing a trade in which the second entity's order is at least partially accepted, by at least comparing each of the multiplicity of securities portfolios, as each securities portfolio would exist before and after execution of the trade, to the respective benchmark for each securities portfolio.

7. A computer-implemented method as in claim 6, wherein (e) comprises notifying certain of the entities holding securities portfolios that an opportunity to improve their respective portfolios exist.

8. A computer-implemented method as in claim 1, further comprising receiving constraints on the first entity's securities portfolio from the first entity, and determining whether executing the trade would violate any of the constraints.

9. A computer-implemented method as in claim 1, further comprising determining whether executing the trade would violate compliance rules.

10. A computer-implemented method as in claim 1, further comprising receiving a notification of acceptance of the opportunity from the first entity.

11. A computer-implemented method as in claim 10, further comprising executing the trade.

12. A computer-implemented method as in claim 1, further comprising recommending to the first entity a security to sell from the securities portfolio in conjunction with accepting the opportunity.

13. A computer-implemented method as in claim 1, further comprising recommending to the first entity a security to buy in conjunction with accepting the opportunity.

14. A computer-implemented method as in claim 7, wherein the first of the certain entities to accept the opportunity locks the relevant portion of the trade.

15. A computer-implemented method as in claim 1, wherein the benchmark is a securities index.

16. A computer-implemented method as in claim 1, wherein (e) comprises providing order price, size and security identification information to the first entity.

17. A computer-implemented method as in claim 1, wherein the benchmark is established based at least on information received from the first entity.

18. A computer-implemented method as in claim 1, wherein the second entity is anonymous to the first entity until the order is accepted.

19. A computer-implemented method as in claim 16, wherein the first entity is anonymous to the second entity until the opportunity is accepted.

20. A computer-implemented method as in claim 11, wherein the second entity is anonymous to the first entity before, during and after the trade is executed.

21. A computer-implemented method as in claim 20, wherein the first entity is anonymous to the second entity before, during and after the trade is executed.

22. A computer-implemented method as in claim 1, wherein receipt of the second entity's order is received directly from the second entity without any delegates.

23. A computer-implemented method as in claim 1 wherein (d) further comprises analyzing the tax consequences of the execution.

24. A computer-implemented method as in claim 1 wherein (d) further comprises analyzing the transaction costs of the execution.

25. A computer-implemented method as in claim 1 wherein (d) further comprises analyzing securities rankings.

26. A computer system for facilitating securities trading, comprising:
a coverage trader module which receives investment information regarding a first entity's securities portfolio, the investment information including a data record of current securities holdings in the portfolio and a benchmark for the portfolio; and
an order manager module which receives a second entity's order;
the coverage trader module being configured to compare the portfolio with the current securities holdings to the benchmark to produce a first result;
the coverage trader module being further configured to compare the portfolio, as the portfolio would exist after execution of a trade in which at least a portion of the second entity's order is accepted, to the benchmark to produce a second result;
the coverage trader module being further configured to compare the first result to the second result to determine whether the second entity's order represents an opportunity for improving the first entity's portfolio relative to the benchmark; and
the coverage trader module being further configured to notify the first entity of an opportunity for improving the first entity's portfolio relative to the benchmark.

27. A computer system as in claim 26, further comprising a compliance manager module which checks the effect of the first entity accepting at least a portion of the second entity's order for compliance with government regulations, before the first entity is notified of an opportunity.

28. A computer system as in claim 26, wherein the coverage trader module is configured to compare the portfolio, as the portfolio would exist after execution of a trade in which the second entity's order is entirely accepted, to the benchmark to produce the second result.

29. A computer system as in claim 26, wherein the coverage trader module receives investment information for a multiplicity of securities portfolios, and the coverage trader module is configured to determine the effect, on each of the multiplicity of securities portfolios, of executing a trade in which the second entity's order is accepted.

30. A computer system as in claim 29, wherein the order manager module is configured to receive a multiplicity of orders, and the coverage trader module is configured to determine the effect, for each of the multiplicity of orders and for each of the multiplicity of securities portfolios, of executing a trade in which a second entity's order is accepted.

31. A computer system as in claim 26, wherein the second entity is anonymous to the first entity at least until the second entity's order is accepted by the first entity.

32. A computer system as in claim 26, wherein the first entity is anonymous to the second entity at least until the opportunity is accepted.

33. A computer system as in claim 26, wherein the second entity is anonymous to the first entity before, during and after the trade is executed.

34. A computer system as in claim 33, wherein the first entity is anonymous to the second entity before, during and after the trade is executed.

35. A computer system comprising:
means for receiving information regarding a first entity's securities holdings in a securities portfolio;
means for receiving an indication of a benchmark for the first entity's securities portfolio;
means for receiving a second entity's order with respect to a specified security;
means for comparing the portfolio with the current securities holdings to the benchmark to produce a first result;
means for comparing the portfolio, as the portfolio would exist after execution of a trade in which the second entity's order is accepted, to the benchmark to produce a second result;
means for comparing the first result to the second result to determine whether the first entity's order represents an opportunity for improving the second entity's portfolio relative to the benchmark;
means for notifying the first entity of an opportunity to improve the portfolio relative to the benchmark.

36. A computer-readable medium having computer-readable signals stored thereon that define instructions that, as a result of being executed by a computer, instruct the computer to perform a method comprising acts of:
(a) receiving information regarding a first entity's securities holdings in a securities portfolio;
(b) receiving an indication of a benchmark for the first entity's securities portfolio;
(c) receiving a second entity's order or indication of interest with respect to a specified security;
(d) in response to the receipt of the order or indication of interest, determining the effect, on the first entity's securities portfolio, of executing a trade in which the second entity's order or indication of interest is accepted, by at least comparing the first entity's securities portfolio, as the securities portfolio would exist after execution of the trade, to the benchmark for the first entity's securities portfolio; and
(e) notifying the first entity of an opportunity to improve its portfolio.

37. A computer-readable medium as in claim 36, wherein act (d) comprises, in response to the receipt of the order or indication of interest, determining the effect, on the first entity's securities portfolio, of executing a trade in which at least a portion of the second entity's order or indication of interest is accepted.

38. A computer-readable medium as in claim 36, wherein:
act (a) comprises receiving information regarding securities holdings in a multiplicity of securities portfolios;
act (b) comprises receiving an indication of a benchmark for each of the multiplicity of securities portfolios; and
act (d) comprises determining the effect, on each of the multiplicity of securities portfolios, of executing a trade in which the second entity's order or indication of interest is accepted, by at least comparing each of the multiplicity of securities portfolios, as each securities portfolio would exist after execution of the trade, to the benchmark for each securities portfolio.

39. A computer-readable medium as in claim 38, wherein act (e) comprises notifying the first entity of an opportunity to improve its portfolio without providing the identity of the second entity.

40. A computer-readable medium as in claim 38, wherein act (d) further comprises comparing the first entity's securities portfolio, as it exists before execution of the trade, to the benchmark for the first entity's securities portfolio.
